(19) United States
(12) Patent Application Publication
(10) Pub. No.: US 2024/0251782 A1
(43) Pub. Date: Aug. 1, 2024

(54) Mobile self erecting elevated base

(71) Applicant: Charles Gersch, Stonewall, LA (US)

(72) Inventor: Charles Gersch, Stonewall, LA (US)

(21) Appl. No.: 18/075,501

(22) Filed: Dec. 6, 2022

Related U.S. Application Data
(63) Continuation of application No. 17/963,116, filed on Oct. 10, 2022, now abandoned.

(51) Int. Cl. A01M 31/02

(52) U.S. Cl. CPC A01M 31/02

(57) ABSTRACT

The hunting industry for years has needed the use for elevated equipment. In order for hunters to excel, they opt to uses bases or stands that allow them to properly set up. Many of these bases allow for vertical height however other equipment is needed to move them into place. The hunter would benefit from these stands or bases having the ability to be easily moved and positioned. The mobile self erecting elevated base can help solve the problem of portability. The design allows for improved mobility and positioning.

### FIELD OF THE INVENTION

The present invention relates generally to a mobile self-erecting elevated base for hunting blind or outdoor sport purpose. More specifically, the present invention is a device that is a base that is easily portable and can be conveniently set up.

### BACKGROUND OF THE INVENTION

Within the hunting industry much of the necessary equipment has improved over the years along with the development of technology around the world. In order to excel at hunting many hunters opt to use bases and stands to allow themselves to properly setup and get ready for their hunt. Many bases are designed to be elevated off the ground with a plurality of legs or methods of fastening to a tree or vertical surface. Many of these bases allow for a hunter to get the vertical height needed however, many require the base to be moved with several machines and takes a lot of time to assemble in the proper positions. As a hunter these bases need to be easily accessible and transportable to allow the hunter to move and change locations to encounter quality animals.

An objective of the present invention is to provide users with a self-erecting mobile base, to help individuals when out hunting or participating in other outdoor activities. The present invention intends to provide users with a device that can be easily relocated without the need for heavy machinery. In order to accomplish that, a preferred embodiment of the present invention comprises a base, a stand and a plurality of legs. Further, the stand allows the mobile self-erecting elevated base to be maneuvered around. Thus, the present invention is a mobile self-erecting elevated base for hunting and outdoor sports that can be conveniently relocated based on the needs of the individual using the present invention without the need for heavy machinery.

### SUMMARY OF THE INVENTION

The present invention is a mobile self-erecting elevated base to help with mobile hunting and other outdoor sports. The present invention seeks to provide users with a device that can be conveniently set up and utilized by an individual. In order to accomplish this the present invention comprises a base that allows an individual to be positioned within the present invention. Further, the stand allows the present invention to be easily repositioned anywhere that is needed by the individual utilizing the present invention. Additionally, plurality of legs ensures the present invention is designed with an elevated platform. Thus, the present invention is a mobile self-erecting elevated base for hunting and outdoor sports that can be conveniently relocated based on the needs of the individual using the present invention without the need for heavy machinery.

### BRIEF DESCRIPTION OF THE DRAWINGS

FIG. 1 is a perspective view of the present invention.

FIG. 2 is a front view of the present invention.

FIG. 3 is a rear view of the present invention.

FIG. 4 is a right-side view of the present invention.

FIG. 5 is a left-side view of the present invention.

FIG. 6 is a top view of the present invention.

FIG. 7 is a bottom view of the present invention.

### DETAIL DESCRIPTIONS OF THE INVENTION

All illustrations of the drawings are for the purpose of describing selected versions of the present invention and are not intended to limit the scope of the present invention.

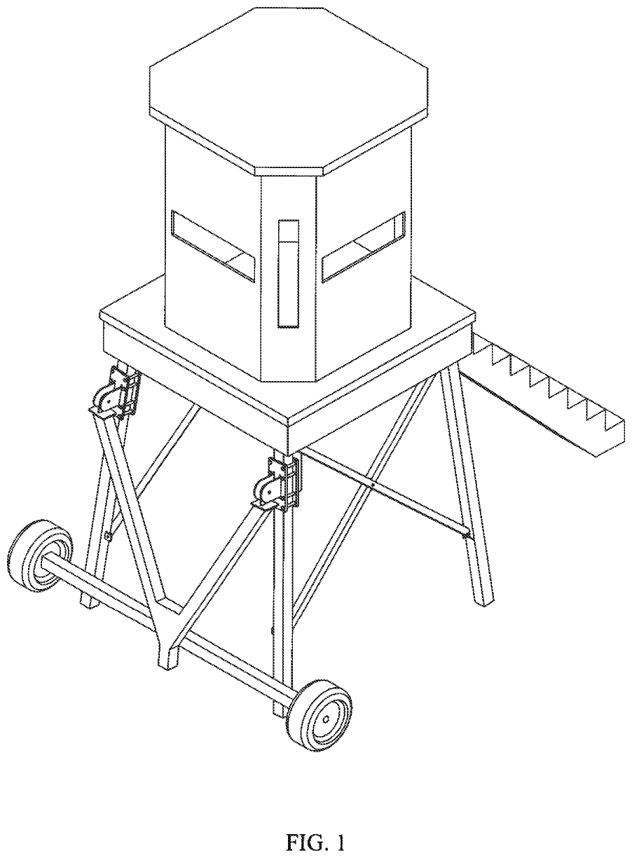

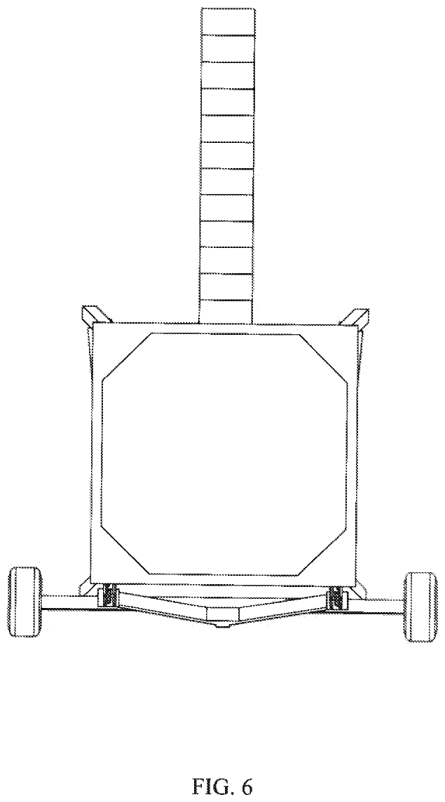

As shown in FIG. 1, the present invention is a mobile self-erecting elevated base. An objective of the present invention is to provide users with a mobile base that can be easily maneuvered without needing heavy machinery. The present invention intends to provide users with a device that can be conveniently setup to assist with hunting and other outdoor sports. To accomplish this the present invention comprises a base, a stand, and a plurality of legs. As seen in FIG. 6, many of these components allow for an individual to utilize the present invention as a portable self-contained base or stand. The stand is positioned at the bottom of the base creating a hollow area. Below the base, extending downward is the plurality of leg. Thus, the present invention is a mobile self-erecting elevated base for hunting and outdoor sports that can be conveniently relocated based on the needs of the individual using the present invention without the need for heavy machinery.

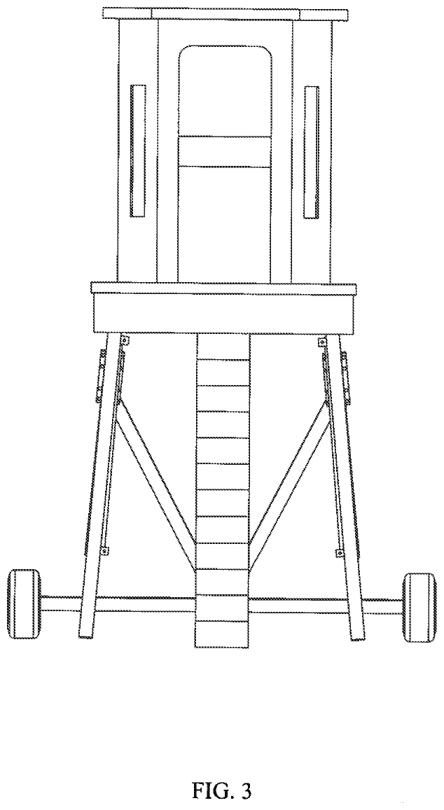

The present invention creates cover for mobile hunting and outdoor sports with the base. The base is made of a wooden durable material with a hollow interior with eight sides where four sides are equal and four other sides are equal. In its preferred embodiment the base comprises a roof, a doorway, and a plurality of slots. The roof is located at the top of the base with a similar but slightly larger cross section as seen in FIG. 3. The roof is made of a similar material as the base. At the rear side of the base is the doorway that is designed as a rectangular cutout with curved corners that allows for an individual to easily walk through the opening. The plurality of slots is positioned on each side of the base with a thin rectangular shape to allow for easy visibility when an individual is stationed within the present invention. It should be further noted that, the base can be created in many various shapes and sizes and plurality of slots can be oriented in various ways while still staying within the scope of the present invention.

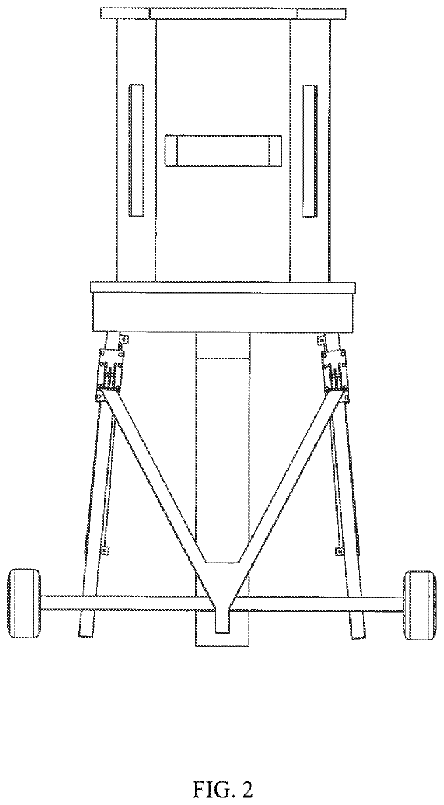

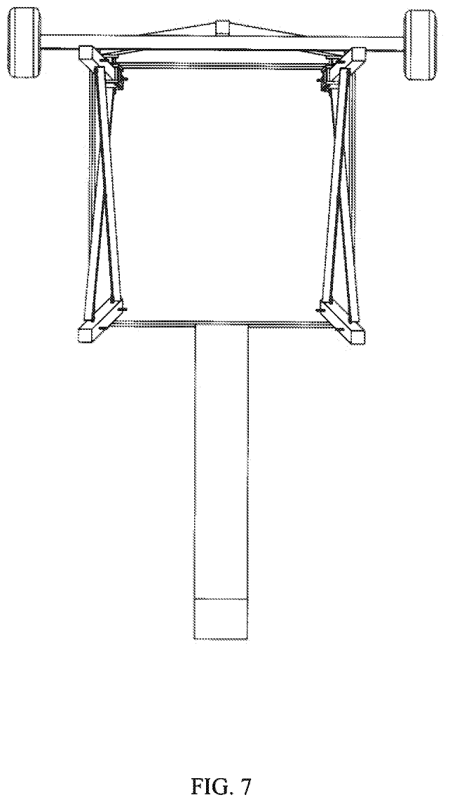

The stand connects with the base at the bottom via the platform. In its preferred embodiment the stand comprises a platform, a stairway, a plurality of hinges, a plurality of supports, and a plurality of wheels. The platform is designed as a metal square frame that covers the bottom of the base to allow an individual to be positioned within the base. The stairway is positioned on the rear side of the stand offset below the doorway on the base and extends downwards and reaches the ground. This design allows for an individual to easily walk up and into the base. The plurality of hinges is positioned along the front side of the stand secured along the front two legs. The plurality of hinges allows for the plurality of supports to be secured and pivot around the plurality of hinges to create one degree of freedom of rotation for the plurality of supports as seen in FIG. 2. At the ends of the plurality of supports is a plurality of wheels that is secured perpendicularly. The plurality of wheels is designed to allow the present invention to be relocated without needing heavy machinery to pickup and maneuver the present invention as shown in FIG. 7.

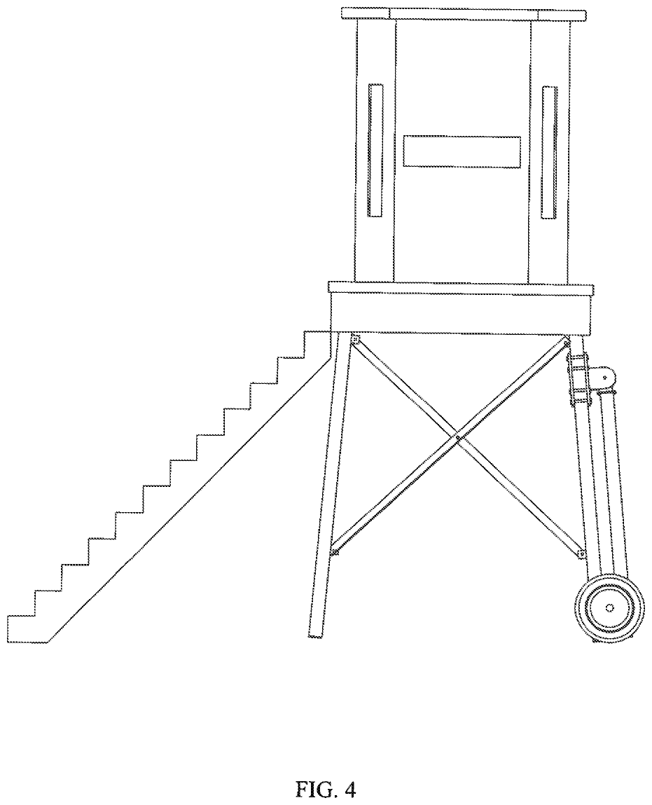

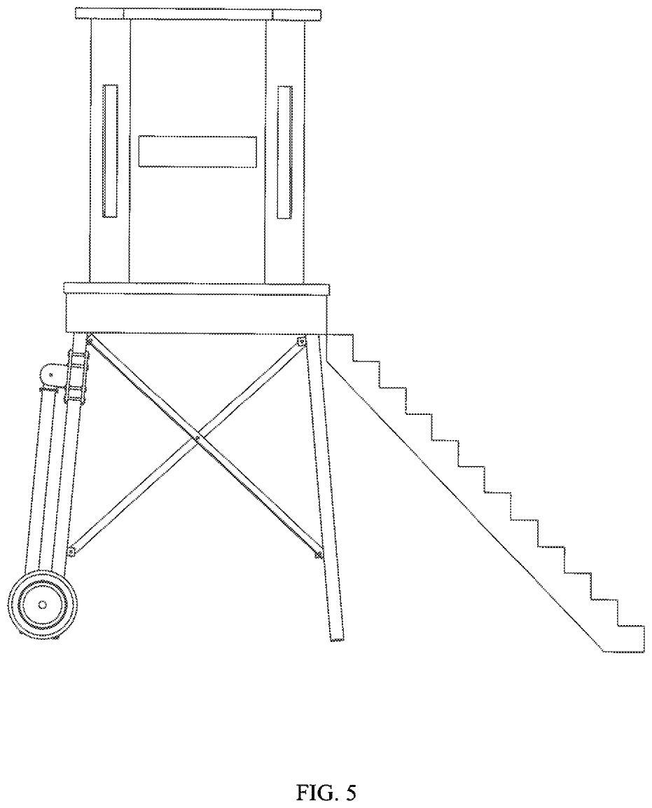

The plurality of legs connects with the stand along the bottom side of the stand in a downward direction. The plurality of legs is made of a similar durable metal material as the stand that allows the present invention to support various loads. In its preferred embodiment the plurality of legs comprises a plurality of crosses and a plurality of bolts. As shown in FIG. 4, the plurality of crosses connects the front and back leg to each other with a thin rectangular metal material that creates a X-shaped design. The plurality of crosses is designed to offer more structural support to the plurality of legs. To ensure the plurality of crosses and the plurality of hinges are properly secured to the plurality of legs the plurality of bolts is positioned along each component. The plurality of bolts secures the plurality of crosses to the plurality of legs and the plurality of hinges to the plurality of legs as seen in FIG. 5. With all the components working in tandem with each other it can be seen that, the present invention is a mobile self-erecting elevated base for hunting and outdoor sports that can be conveniently relocated based on the needs of the individual using the present invention without the need for heavy machinery.

Although the invention has been explained in relation to its preferred embodiment, it is to be understood that many other possible modifications and variations can be made without departing from the spirit and scope of the invention.

The invention claimed is a mobile self erecting elevated base:

1. A mobile self erecting elevated base comprising:
a. a base having eight sides where four sides are equal and four other sides are equal, a roof, a doorway at the rear and a plurality of slots positioned on each side of the base
b. a stand connecting the base at the bottom via the platform comprising a platform, a stairway at the rear offset below the doorway on the base extending downward reaching the ground, a plurality of hinges positioned along the front of the stand secured along the front two legs, a plurality of hinges allowing for the plurality of supports to be secured and pivot around the plurality of hinges to create one degree of freedom of rotation for the plurality of supports and at the at the ends of the plurality of supports is a plurality of wheels secured perpendicularly to allow the present invention to be relocated without needing heavy machinery to pickup and maneuver.
c. a plurality of legs connecting with the stand along the bottom side of the stand in a downward direction comprising a plurality of crosses connecting the front and back legs to each other creating an X-shaped design and a plurality of bolts securing the plurality of crosses to the plurality of legs and the plurality of hinges to the plurality of legs.
All the components working together in tandem with each other shows that the present invention is mobile and self erecting allowing intended users that can be easily relocated without the need for heavy machinery. The present invention creates cover for mobile hunting and outdoor sports with the base. It is to be understood that many other possible modifications and variations can be made without departing from the scope of the invention.
